(19) United States
(12) Patent Application Publication
(10) Pub. No.: US 2011/0083509 A1
(43) Pub. Date: Apr. 14, 2011

(54) Photoacoustic Spectroscopy With Focused Light

(75) Inventors: Youzhi Li, Longmont, CO (US); Edward McKenna, Boulder, CO (US); Andy S. Lin, Boulder, CO (US)

(73) Assignee: Nellcor Puritan Bennett LLC, Boulder, CO (US)

(21) Appl. No.: 12/576,377

(22) Filed: Oct. 9, 2009

(51) Int. Cl. G01N 29/00; G01N 21/00

(52) U.S. Cl. 73/584

(57) ABSTRACT

Photoacoustic measurements utilize emitted light to generate an acoustic response in tissue, with the acoustic response being proportional to the presence of an absorber of the light in the tissue. The present disclosure relates the use of focused light to acquire photoacoustic measurements. In one embodiment, the light is modulated, such as spatially modulated, such that the light may be focused within an otherwise scattering medium, such as tissue.

### BACKGROUND OF THE INVENTION

The present invention relates generally to medical devices and, more particularly, to the use of pulsed photoacoustic spectroscopy in patient monitoring.

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In the field of medicine, doctors often desire to monitor certain physiological characteristics of their patients. Accordingly, a wide variety of devices have been developed for monitoring many such characteristics of a patient. Such devices provide doctors and other healthcare personnel with the information they need to provide the best possible healthcare for their patients. As a result, such monitoring devices have become an indispensable part of modern medicine.

For example, clinicians may wish to measure the concentrations of one or more blood constituents within a patient to monitor the patient's blood flow or blood oxygen saturation, as these parameters may provide insight into the patient's respiratory and/or cardiac function. Deviation from normal or expected values may alert a clinician to the presence of a particular clinical condition. In certain instances it may be possible to measure such parameters in a manner that is not specific to individual or discrete blood vessels of the circulatory system.

For example, generalized absorbance data at known wavelengths of interest may provide information about the differential absorbance and transmission of light at those wavelengths. Such absorption and/or transmission information may be used to calculate physiological information representative of the region illuminated, which typically encompass a wide array of blood vessels and microvasculature. This physiological information may in turn be extrapolated as representative of the organism as a whole, e.g., the arterial oxygen saturation of the organism, and so forth. However, while techniques such as these may be useful for evaluating certain parameters at a high level (e.g. the level of the entire organism), they may not be useful for evaluating localized physiological parameters of a patient, such as parameters related to individual vessels of the vasculature.

### BRIEF DESCRIPTION OF THE DRAWINGS

Advantages of the invention may become apparent upon reading the following detailed description and upon reference to the drawings in which:

FIG. 1 is a block diagram of a patient monitor and photoacoustic sensor, in accordance with an embodiment;

FIG. 2 depicts a prior art photoacoustic measurement; and

FIG. 3 depicts a photoacoustic measurement in accordance with an embodiment.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In certain medical contexts it may be desirable to ascertain various localized physiological parameters, such as parameters related to individual blood vessels or other discrete components of the vascular system. Examples of such parameters may include oxygen saturation, hemoglobin count, perfusion, and so forth for an individual blood vessel. One approach to measuring such localized parameters is referred to as photoacoustic spectroscopy.

Photoacoustic spectroscopy utilizes light directed into a patient's tissue to generate acoustic pulses that may be detected and resolved to determine localized physiological information of interest. In particular, the light energy directed into the tissue may be provided at particular wavelengths that correspond to the absorption profile of one or more blood or tissue constituents of interest. In certain embodiments, the light is emitted as pulses (i.e., pulsed photoacoustic spectroscopy), though in other embodiments the light may be emitted in a continuous manner (i.e., continuous photoacoustic spectroscopy). The light absorbed by the constituent of interest results in a proportionate increase in the kinetic energy of the constituent (i.e., the constituent is heated), which results in the generation of ultrasonic shock waves. The ultrasonic shock waves may be detected and used to determine the amount of light absorption, and thus the quantity of the constituent of interest, in the illuminated region. For example, the detected ultrasound energy may be proportional to the optical absorption coefficient of the blood or tissue constituent and the fluence of light at the wavelength of interest at the localized region being interrogated, e.g., a specific blood vessel.

One problem that may arise in photoacoustic spectroscopy may be attributed to the tendency of the emitted light to diffuse or scatter in the tissue of the patient. As a result, light emitted toward an internal structure or region, such as a blood vessel, may be diffused prior to reaching the region so that amount of light reaching the region is less than desired. Therefore, due to the diffusion of the light, less light may be available to be absorbed by the constituent of interest in the target region, thus reducing the ultrasonic waves generated at the target region of interest, such as a blood vessel. Therefore, the light-to-ultrasound conversion efficiency may be reduced due to the light diffusing properties of the intervening tissue between the surface of the skin and the internal structure or region of interest. In one embodiment of the present disclosure, the emitted light may be focused on an internal region of interest to reduce or eliminate the effects of light diffusion and to thereby improve the light-to-ultrasound conversion efficiency at the internal region of interest.

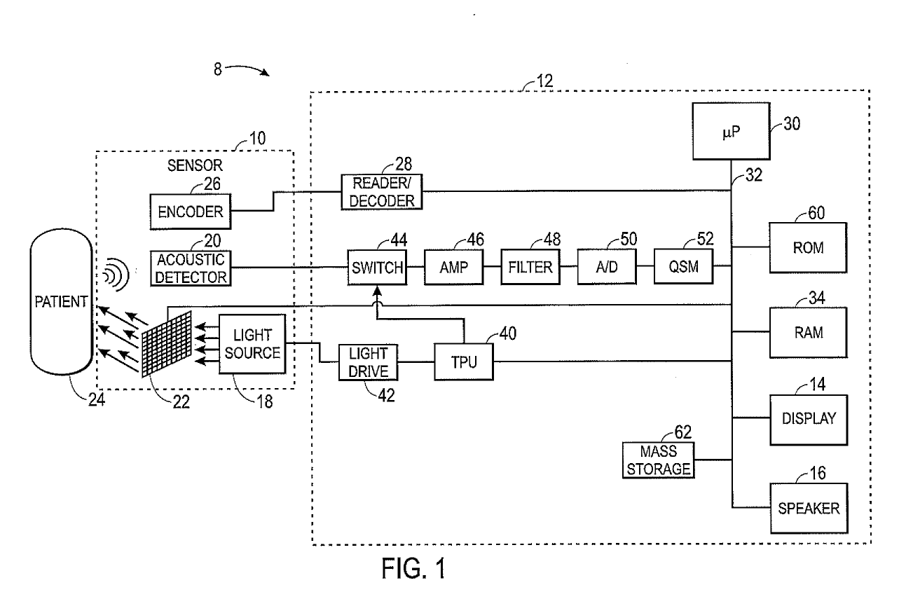

With this in mind, FIG. 1 depicts a block diagram of a photoacoustic spectroscopy system 8 in accordance with embodiments of the present disclosure. The system 8 includes a photoacoustic spectroscopy sensor 10 and a monitor 12. The sensor 10 may emit spatially modulated light at certain wavelengths into a patient's tissue and may detect acoustic shock waves generated in response to the emitted light. The monitor 12 may be capable of calculating physiological characteristics based on signals received from the sensor 10 that correspond to the detected acoustic shock waves. The monitor 12 may include a display 14 and/or a speaker 16 which may be used to convey information about the calculated physiological characteristics to a user. The sensor 10 may be communicatively coupled to the monitor 12 via a cable or, in some embodiments, via a wireless communication link.

In one embodiment, the sensor 10 may include a light source 18 and an acoustic detector 20, such as an ultrasound transducer. The present discussion generally describes the use of pulsed light sources to facilitate explanation. However, it should be appreciated that the photoacoustic sensor 10 may also be adapted for use with continuous wave light sources in other embodiments. In certain embodiments, the light source 18 may be associated with one or more optical fibers for conveying light from one or more light generating components to the tissue site.

The photoacoustic spectroscopy sensor 8 may include a light source 18 and an acoustic detector 20 that may be of any suitable type. For example, in one embodiment the light source 18 may be one, two, or more light emitting components (such as light emitting diodes) adapted to transmit light at one or more specified wavelengths. In certain embodiments, the light source 18 may include a laser diode or a vertical cavity surface emitting laser (VCSEL). The laser diode may be a tunable laser, such that a single diode may be tuned to various wavelengths corresponding to a number of different absorbers of interest in the tissue and blood. That is, the light may be any suitable wavelength or wavelengths (such as a wavelength between about 500 nm to about 1000 nm or between about 600 nm to about 900 nm) that is absorbed by a constituent of interest in the blood or tissue. For example, wavelengths between about 500 nm to about 600 nm, corresponding with green visible light, may be absorbed by deoxyhemoglobin and oxyhemoglobin. In other embodiments, red wavelengths (e.g., about 600 nm to about 700 nm) and infrared or near infrared wavelengths (e.g., about 800 nm to about 1000 nm) may be used. In one embodiment, the selected wavelengths of light may penetrate between 1 cm to 2 cm into the tissue of the patient 24.

The emitted light may be intensity modulated at any suitable frequency, such as from 1 MHz to 10 MHz or more. In one embodiment, the light source 18 may emit pulses of light at a suitable frequency where each pulse lasts 10 nanoseconds or less and has an associated energy of a 1 mJ or less, such as between 1 μJ to 1 mJ. In such an embodiment, the limited duration of the light pulses may prevent heating of the tissue while still emitting light of sufficient energy into the region of interest to generate the desired acoustic shock waves when absorbed by the constituent of interest.

In one embodiment, as discussed herein, the light emitted by the light source 18 may be spatially modulated, such as via a modulator 22. For example, in one embodiment, the modulator 22 may be a spatial light modulator, such as a Holoeye® LC-R 2500 liquid crystal spatial light modulator. In one such embodiment, the spatial light modulator may have a resolution of 1024×768 pixels or any other suitable pixel resolution. During operation, the pixels of the modulator 22 may be divided into subgroups (such as square or rectangular subarrays or groupings of pixels) and the pixels within a subgroup may generally operate together. For example, the pixels of a modulator 22 may be generally divided into square arrays of 10×10, 20×20, 40×40, or 50×50 pixels. In one embodiment, each subgroup of pixels of the modulator 22 may be operated independently of the other subgroups. The pixels within a subgroup may be operated jointly (i.e., are on or off at the same time) though the subgroups themselves may be operated independently of one another. In this manner, each subgroup of pixels of the modulator 22 may be operated so as to introduce phase differences at different spatial locations within the emitted light. That is, the modulated light that has passed through one subgroup of pixels may be at one phase and that phase may be the same or different than the modulated light that has passed through other subgroups of pixels, i.e., some segments or portions of the modulated light wavefront may be ahead of or behind other portions of the wavefront. In one embodiment, the modulator 22 may be associated with additional optical components (e.g., lenses, reflectors, refraction gradients, polarizers, and so forth) through which the spatially modulated light passes before reaching the tissue of the patient 24.

In one embodiment, the acoustic detector 20 may be one or more ultrasound transducers suitable for detecting ultrasound waves emanating from the tissue in response to the emitted light and for generating a respective optical or electrical signal in response to the ultrasound waves. For example, the acoustic detector 20 may be suitable for measuring the frequency and/or amplitude of the ultrasonic shock waves, the shape of the ultrasonic shock waves, and/or the time delay associated with the ultrasonic shock waves with respect to the light emission that generated the respective shock waves. In one embodiment an acoustic detector 20 may be an ultrasound transducer employing piezoelectric or capacitive elements to generate an electrical signal in response to acoustic energy emanating from the tissue of the patient 24, i.e., the transducer converts the acoustic energy into an electrical signal.

In one implementation, the acoustic detector 20 may be a low finesse Fabry-Perot interferometer mounted on an optical fiber. In such an embodiment, the incident acoustic waves emanating from the probed tissue modulate the thickness of a thin polymer film. This produces a corresponding intensity modulation of light reflected from the film. Accordingly, the acoustic shock waves are converted to optical information, which is transmitted through the optical fiber to an upstream optical detector, which may be any suitable detector. In some embodiments, a change in phase of the detected light may be detected via an appropriate interferometry device which generates an electrical signal that may be processed by the monitor 12. The use of a thin film as the acoustic detecting surface allows high sensitivity to be achieved, even for films of micrometer or tens of micrometers in thickness. In one embodiment, the thin film may be a 0.25 mm diameter disk of 50 micrometer thickness polyethylene terepthalate with an at least partially optically reflective (e.g., 40% reflective) aluminum coating on one side and a mirror reflective coating on the other (e.g., 100% reflective) that form the mirrors of the interferometer. The optical fiber may be any suitable fiber, such as a 50 micrometer core silica multimode fiber of numerical aperture 0.1 and an outer diameter of 0.25 mm.

In one embodiment, the photoacoustic sensor 10 may include a memory or other data encoding component, depicted in FIG. 1 as an encoder 26. For example, the encoder 26 may be a solid state memory, a resistor, or combination of resistors and/or memory components that may be read or decoded by the monitor 12, such as via reader/decoder 28, to provide the monitor 12 with information about the attached sensor 10. For example, the encoder 26 may encode information about the sensor 10 or its components (such as information about the light source 18 and/or the acoustic detector 20). Such encoded information may include information about the configuration or location of photoacoustic sensor 10, information about the type of lights source(s) 18 present on the sensor 10, information about the wavelengths, pulse frequencies, pulse durations, or pulse energies which the light source(s) 18 are capable of emitting, information about the nature of the acoustic detector 20, and so forth. This information may allow the monitor 12 to select appropriate algorithms and/or calibration coefficients for calculating the patient's physiological characteristics, such as the amount or concentration of a constituent of interest in a localized region, such as a blood vessel.

In one embodiment, signals from the acoustic detector 20 (and decoded data from the encoder 26, if present) may be transmitted to the monitor 12. The monitor 12 may include data processing circuitry (such as one or more processors 30, application specific integrated circuits (ASICS), or so forth) coupled to an internal bus 32. Also connected to the bus 32 may be a RAM memory 34, a speaker 16 and/or a display 14. In one embodiment, a time processing unit (TPU) 40 may provide timing control signals to light drive circuitry 42, which controls operation of the light source 18, such as to control when, for how long, and/or how frequently the light source 18 is activated, and if multiple light sources are used, the multiplexed timing for the different light sources.

TPU 40 may also control or contribute to operation of the acoustic detector 20 such that timing information for data acquired using the acoustic detector 20 may be obtained. Such timing information may be used in interpreting the shock wave data and/or in generating physiological information of interest from such acoustic data. For example, the timing of the acoustic data acquired using the acoustic detector 20 may be associated with the light emission profile of the light source 18 during data acquisition. Likewise, in one embodiment, data acquisition by the acoustic detector 20 may be gated, such as via a switching circuit 44, to account for differing aspects of light emission. For example, operation of the switching circuit 44 may allow for separate or discrete acquisition of data that corresponds to different respective wavelengths of light emitted at different times.

In one embodiment, the received signal from the acoustic detector 20 may be amplified (such as via amplifier 46), may be filtered (such as via filter 48), and/or may be digitized if initially analog (such as via an analog-to-digital converter 50). The digital data may be provided directly to the processor 30, may be stored in the RAM 34, and/or may be stored in a queued serial module (QSM) 52 prior to being downloaded to RAM 34 as QSM 52 fills up. In one embodiment, there may be separate, parallel paths for separate amplifiers, filters, and/or A/D converters provided for different respective light wavelengths or spectra used to generate the acoustic data.

The data processing circuitry (such as processor 30) may derive one or more physiological characteristics based on data generated by the photoacoustic sensor 12. For example, based at least in part upon data received from the acoustic detector 20, the processor 30 may calculate the amount or concentration of a constituent of interest in a localized region of tissue or blood using various algorithms. In one embodiment, these algorithms may use coefficients, which may be empirically determined, that relate the detected acoustic shock waves generated in response to pulses of light at a particular wavelength or wavelengths to a given concentration or quantity of a constituent of interest within a localized region. In addition, in one embodiment the data processing circuitry (such as processor 30) may communicate with the TPU 40 and/or the light drive 42 to spatially modulate the wave front of light emitted by the light source 18 based on one or more algorithms, as discussed herein.

In one embodiment, processor 30 may access and execute coded instructions, such as for implementing the algorithms discussed herein, from one or more storage components of the monitor 12, such as the RAM 34, the ROM 60, and/or the mass storage 62. For example, code encoding executable algorithms may be stored in a ROM 60 or mass storage device 62 (such as a magnetic or solid state hard drive or memory or an optical disk or memory) and accessed and operated according to processor 30 instructions. Such algorithms, when executed and provided with data from the sensor 10, may calculate a physiological characteristic as discussed herein (such as the concentration or amount of a constituent of interest). Once calculated, the physiological characteristic may be displayed on the display 14 for a caregiver to monitor or review.

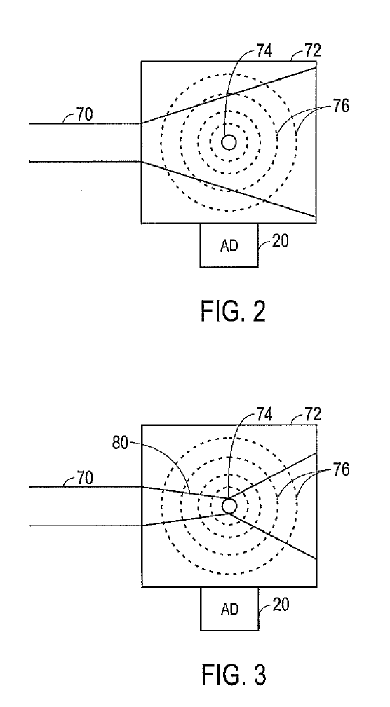

With the foregoing system discussion in mind, light emitted by the light source 18 of the photoacoustic sensor 10 may be used to generate acoustic signals in proportion the amount of an absorber (e.g., a constituent of interest) in a targeted localized region. However, as noted above, the emitted light may be scattered upon entering the tissue, with the amount of scatter or dispersion increasing as the light penetrates deeper into the tissue. Thus, for localized regions or structures of interest, such as blood vessels, the greater the depth of such vessels beneath the tissue surface, the greater the dispersion of the emitted light before reaching the localized region or structure. For example, referring to FIG. 2, a conventional light pulse 70 may begin to disperse upon entering a tissue 72. As a result, the intensity and/or fluence of the emitted light incident upon the localized region of interest 74, such as blood vessel, may be reduced, resulting in less absorption by the constituent of interest within the localized region 74 and proportionately less energetic acoustic waves 76 being generated. This may yield a relatively low strength signal at the acoustic detector 20 relative to the noise associated with the measurement.

Turning to FIG. 3, in one embodiment, the strength of the measured signal may be increased by focusing the light pulse 70 on the region of interest 74, as denoted by focused beam 80. Such focusing may result in less dispersal or scattering of the light prior to reaching the region of interest 74 and correspondingly greater intensity and/or fluence of the light at the region of interest 74. As a result more absorption of light by the constituent of interest may occur in the region of interest 74, yielding proportionately more energetic acoustic waves 76 with a corresponding higher signal-to-noise ratio at the acoustic detector 20.

In one embodiment, the light pulse 70 may be focused on one or more concurrent focal points by spatially modulating the light pulse 70 to yield an inverse wave diffusion effect upon entering the scattering medium, i.e., the patient tissue. In effect, multi-path interference may be employed so that the scattering process itself focuses the emitted light onto the desired focal point or points. In particular, to the extent that at any given time the disorder in a medium is fixed or determinable, light scattering in the medium is deterministic and this knowledge may be utilized to modulate the emitted light such that the resulting scatter in the medium results in the light being concentrated or focused on a desired region of interest.

In one embodiment the light pulse 70 may be spatially modulated using a liquid crystal phase modulator or other suitable modulator 22. For example, to the extent that a conventional light pulse may have a planar wavefront, a spatially modulated light pulse, as discussed herein, may have a wavefront that is not planar and instead may be shaped by breaking the wavefront up into numerous sub-planes (e.g., square or rectangular segments) that are not all at the same phase, such that different portions of the wavefront reach the tissue surface at different times. The operation of the modulator 22 may be updated or iterated based upon feedback from the acoustic detector 20. For example, in one embodiment the signals generated by the acoustic detector 20 may be processed by a processor 30 which may in turn evaluate the processed signal in accordance with one or more algorithms or thresholds (such as a signal-to-noise threshold) and adjust operation of the modulator 22 accordingly. In one embodiment adaptive learning algorithms or other suitable analysis algorithms (e.g., neural networks, genetic algorithms, and so forth) may be employed to evaluate the processed signal and to make adjustments to the modulation.

In one embodiment, an algorithm may be employed to generate the inverse diffusion wavefront. One such algorithm may utilize the linearity of the scattering process in the tissue to generate the diffusion wavefront. For example, in one embodiment, the inverse diffusion wavefront may be generated in accordance with the equation:

$${E}_{m} = {\sum }_{n = 1}^{N} {t}_{mn} {A}_{n} {e}^{{iφ}_{n}} \qquad ( 1 )$$

where Eₘ is the linear combination of the fields coming from N different wavefront segments generated by the modulator 22, Aₙ, is the amplitude of the light reflected from segment n, φₙ is the phase of the light reflected from segment n, and tₘₙ is the scattering in the sample and propagation through the optical system. In accordance with such an equation, the magnitude of Eₘ may be maximized when all terms are in phase. The optimal phase for a segment, n, of the light pulse wavefront at a given time may be determined by cycling its phase from 0 to 2π while the phase of other segments is held constant. This process may then be repeated for each segment. The optimal phase for each segment for which the target intensity is highest may then be stored. Once the optimized phase is known for each segment of the wavefront, the modulator 22 may be programmed based on the stored values such that differential activation of the pixels or subgroups of pixels defined for the modulator 22 (such as for a liquid crystal phase modulator) spatially modulates a light pulse incident upon the modulator 22. That is, differential adjustment of the opacity of elements defined by the modulator 22 (such as square or rectangular groupings of pixels of a liquid crystal element) may yield a light pulse with a wavefront in which different segments or portions of the wavefront are out of phase, i.e., staggered with respect to one another. When the resulting spatially modulated light pulse is transmitted through the tissue, the contributions attributable to each modulated portion of the wavefront of the light pulse may constructively interfere with one another to yield the desired light intensity at the localized region of interest, as depicted in FIG. 3.

While the preceding describes one implementation for generating a spatially modulated wavefront, such a wavefront may also be generated by modeling the optical field E at a point r_{b} within a medium in accordance with:

E(r_{b})=∫g(r_{b},rₐ)φ(rₐ)d³rₐ (2)

in which g is Green's function describing propagation from φ(rₐ) to point r_{b}. In an embodiment, each segment of the phase modulator is treated as a planar source having amplitude A and phase φ. If the phase modulator is assumed to be illuminated uniformly, the amplitudes A at each segment may be assumed to be equal. By integrating the surface area S of each of the N segments, Equation (2) may be represented as:

$$E ( {r}_{b} ) = {\sum }_{a}^{N} {\int }_{{S}_{a}}^{ } g ( {r}_{b} , {r}_{a} ) {d}^{2} {r}_{a} A {e}^{iφa} \qquad ( 3 )$$

which in turn yields

$$E ( {r}_{b} ) = A {\sum }_{a}^{N} {g}_{ba} {e}^{i φ a} . \qquad ( 4 )$$

Changing the phase of a segment a of the phase modulator 22 while holding the phase of other segments unchanged causes the intensity I at point r_{b} to respond in accordance with:

I(r_{b})≡|E(r_{b})|²=I_{0b}+2ARe(E*_{bā}g_{ba}e^{iφa}) (5)

in which:

I_{0b}≡|E_{bā}|²+A²|g_{ba}|² (6)

and

$${E}_{b \overline{a}} ≡ A {\sum }_{{a}^{′} \neq a}^{N} {g}_{{ba}^{′}} {e}^{i {φ}_{a}^{′}} \approx E ( {r}_{b} ) . \qquad ( 7 )$$

Where the number of segments N is large E_{bā}≈E(r_{b}) and is therefore essentially the same across all segments. By analyzing each segment α in this manner, the coefficients g_{ba} may be measured up to an unknown common prefactor E(r_{b}). By determining the coefficients g_{ba}, the optical field at point r_{b} (e.g., E(r_{b})) may be maximized by setting φₐ equal to −arg(g_{ba}) for each of the segments. This combination of segment phases thus can yield an aggregate light intensity maximum at the region of interest:

$${E}_{max} ( {r}_{b} ) = A {\sum }_{a}^{N} \vert {g}_{ba} \vert \qquad ( 8 )$$

in which the different light channels associated with each channel will undergo constructive interference to reach the region of interest.

The amount of intensity enhancement observed at the localized region 74 may be related to the numbers of segments or regions into which the wavefront of the light pulse 70 is broken. To the extent that the constants tₘₙ are statistically independent and obey a circular Gaussian distribution, the expected enhancement, η, may be represented as:

$$η = \frac{π}{4} ( N - 1 ) + 1 \qquad ( 9 )$$

where η is the ratio between the enhanced light intensity at the region of interest and the average light intensity at the region of interest prior to enhancement.

Thus, in accordance with the present disclosure, emitted light pulse may be spatially modulated so as to converge on a region of interest within an otherwise scattering medium (e.g., tissue). In the context of photoacoustic spectroscopy, such convergence may be used to increase the fluence of light at the internal region of interest and to, thereby, improve the signal-to-noise ratio of the generated acoustic signal. That is, focusing the emitted light on the internal region (such as by spatial modulation of the respective light pulse wavefronts) generates a stronger acoustic signal, thereby improving the measurement process.

While the disclosure may be susceptible to various modifications and alternative forms, specific embodiments have been shown by way of example in the drawings and have been described in detail herein. However, it should be understood that the embodiments provided herein are not intended to be limited to the particular forms disclosed. Indeed, the disclosed embodiments may be applied to various types of medical devices and monitors, as well as to electronic device in general. Rather, the various embodiments may cover all modifications, equivalents, and alternatives falling within the spirit and scope of the disclosure as defined by the following appended claims.

What is claimed is:

1. A photoacoustic system, comprising:
a light emitting component capable of emitting one or more wavelengths of light;
a light modulating component capable of spatially modulating light emitted by the light emitting component; and
an acoustic detector capable of detecting acoustic energy generated in response to the spatially modulated light.

2. The photoacoustic system of claim 1, wherein the light emitting component emits discrete pulses of light.

3. The photoacoustic system of claim 1, wherein one or more of the light emitting component, the light modulating component, or the acoustic detector are provided in a sensor body.

4. The photoacoustic system of claim 1, comprising a monitor in communication with one or more of the light emitting component, the light modulating component, or the acoustic detector.

5. The photoacoustic system of claim 1, wherein the light emitting component comprises one or more light emitting diodes, one or more laser diodes, or a vertical cavity surface emitting laser.

6. The photoacoustic system of claim 1, wherein the acoustic detector comprises one or more of an ultrasound transducer or an interferometer.

7. The photoacoustic system of claim 1, wherein the light modulating component comprises a liquid crystal spatial light modulator.

8. A photoacoustic system, comprising:
a pulsed light source capable of emitting light pulses at one or more respective wavelengths of light;
a modulator capable of modulating a wavefront associated with each respective light pulse such that each wavefront exhibits different phases at different locations; and
an acoustic detector capable of generating a signal in response to acoustic shock waves generated in response to the emitted light pulses.

9. The photoacoustic system of claim 8, wherein the one or more respective wavelengths are between about 500 nm to about 1,000 nm.

10. The photoacoustic system of claim 8, wherein the signal corresponds to a concentration or quantity of an absorber of the emitted light pulses.

11. The photoacoustic system of claim 8, wherein each light pulse lasts ten nanoseconds or less.

12. The photoacoustic system of claim 8, wherein each light pulse has an associated energy of 1 mJ or less.

13. The photoacoustic system of claim 8, wherein the modulator comprises a plurality of subgroups of pixels.

14. The photoacoustic system of claim 13, wherein each subgroup of pixels operates independently of the other subgroups.

15. The photoacoustic system of claim 8, comprising a sensor body comprising one or more of the pulsed light source, the modulator, or the acoustic detector.

16. The photoacoustic system of claim 8, comprising a monitor capable of communicating with one or more of the pulsed light source, the modulator, or the acoustic detector.

17. A method for generating acoustic pulses, comprising:
spatially modulating one or more light pulses;
emitting the one or more spatially modulated light pulses toward a medium;
detecting one or more acoustic waves generated within the medium in response to the one or more spatially modulated light pulses;
generating a signal corresponding to the one or more acoustic waves; and
processing the signal to generate one or more measures related to the presence of a light absorber within the medium.

18. The method of claim 17, wherein spatially modulating the one or more light pulses comprises altering a respective wavefront associated with each light pulse such that each respective wavefront comprises different regions at different phases.

19. The method of claim 17, comprising adjusting the spatial modulation of one or more subsequent light pulses based upon the signal.

20. The method of claim 17, wherein processing the signal to generate one or more measures related to the presence of a light absorber within the medium comprises processing the signal to generate a concentration or quantity measure of the light absorber within a localized region of the tissue.
